(19) United States
(12) Patent Application Publication
(10) Pub. No.: US 2013/0312765 A1
(43) Pub. Date: Nov. 28, 2013

(54) Therapeutic Flotation Device

(71) Applicant: Nancy Seck, Regina (CA)

(72) Inventor: Nancy Seck, Regina (CA)

(21) Appl. No.: 13/596,534

(22) Filed: Aug. 28, 2012

(30) Foreign Application Priority Data
Aug. 31, 2011 (CA) 2751276

(51) Int. Cl. A61H 37/00

(52) U.S. Cl. CPC A61H 37/005
USPC 128/845

(57) ABSTRACT

The invention seeks to provide a therapeutic flotation device for use in a pool-based rehabilitation therapy practices for spinal rehabilitation or cervical spine rehabilitation. The flotation device comprises two opposed flotation members configured to contact the lateral sides of the user's head and support it and the neck during rehabilitation practices, which flotation members are connected to each other by means of connecting members positioned across the top of the user's head and across the lower back of the user's head. The flotation and connecting members collectively form a ring that fits generally to the back of the user's head during pool-based exercises.

### FIELD OF THE INVENTION

The invention relates to devices for use in pool-based rehabilitation therapy practices and specifically to devices for use in spinal rehabilitation or cervical spinal rehabilitation.

### BACKGROUND OF THE INVENTION

It is know in the art to employ various forms of flotation devices when engaged in pool-based rehabilitation therapy, specifically to support one or more parts of the body to address the particular nature of the injury or to reduce pain associated with the in-pool activities. The guiding principle, in most cases, is that the flotation device enables the body part to float in a supported position near, or at, the water surface. It is common for devices such as noodles, flotation belts, inflatable collars and buoyant platforms (such as flutter boards) to be employed for such purposes.

A challenge arises, however, in the case of certain injuries under rehabilitation care that may require partial immobilization or enhanced support, as most of the known flotation devices provide only limited support and generally allow a wide range of motion. In the case of rehabilitation activities for persons recovering from spinal injuries or cervical spinal injuries, for example, proper head-neck-torso alignment is crucial while performing cervical rotations in water as to reduce attendant pain, sensitivity or discomfort associated with neck injuries. Rehabilitation can even be hampered if the cervical spine freely rotates without maintaining proper alignment with respect the rest of the body; hence, pool-based programs are known to even employ snorkel gear to enable the head of the user to remain as still as possible keeping the neck in proper alignment to the rest of the body while performing rehabilitation exercises.

Water turbulence in the pool can even cause unwanted rotation(s) of the cervical spine, especially when the person is attempting to float and remain still. The flotation devices are generally incapable of countering the effects of turbulence within the pool environment which may destabilize the neck and head.

In water-based rehabilitation, even if the injury is below the shoulders, the device can help support the neck and head while rehabilitating other body parts. For example, but not limited to, while rehabilitating knee injuries, the floatation device can be used to float the head to help prevent it from sinking.

What is needed, therefore, is a flotation device that can be used in a pool rehabilitation environment which helps to support and stabilize the neck and head of the user. Such a device would preferably be of a simple construction, easy to use and would allow for the proper range of movement in standard rehabilitation exercise

### SUMMARY OF THE INVENTION

The present invention therefore seeks to provide a flotation device for use in pool-based rehabilitation practices. The flotation device according to the present invention comprises two opposed flotation members configured to contact the lateral sides of the user's head, while helping to support their neck and head during the rehabilitation practices. The flotation members are connected to each other by means of connecting members positioned across the top of the user's head and across the lower back of the user's head to help maintain proper alignment and balance. The flotation and connecting members collectively form a ring that fits generally to the back and sides of the user's head during pool-based exercise.

The flotation members may be buoyant, or the connecting members may be buoyant, or both the flotation members and connecting members may be buoyant.

According to a first aspect of the present invention there is provided a flotation device for supporting and aligning a user's head during pool-based rehabilitation therapy, comprising:
first and second opposed, spaced apart flotation members, each having a first end and a second end;
the respective first ends of the second flotation members connected by a first connecting member, and the respective second ends of the first and second flotation members connected by a second connecting member;
such that the first flotation member, first connecting member, second flotation member and second connecting member form a ring defining an open space therein, the open space for receiving the back of the user's head, the first and second flotation members arranged to abut the lateral sides of the user's head.

According to a second aspect of the present invention there is provided a method for using a flotation device in pool-based rehabilitation therapy, the flotation device comprising: first and second opposed, spaced apart flotation members, each having a first end and a second end; the respective first ends of the first and second flotation members connected by a first connecting member, and the respecting second ends of the first and second flotation members connected by a second connecting member; such that the first flotation member, first connecting member, second flotation member and second connecting member form a generally ovoid ring defining an open space therein; the method comprising:
a. positioning the flotation device against the back of a user's head, such that the user's head rests generally within the open space;
b. positioning the first and second flotation members against the lateral sides of the user's head; and
c. proceeding with the pool-based rehabilitation therapy.

In exemplary embodiments of the present invention, the first and second flotation member are contoured to contact the user's head along generally the entire length of each of the first and second flotation members, and the first and second flotation members have angled upper surfaces for receiving and supporting the user's head and flattened symmetric lower surface. The first and second flotation members may be buoyant. For example, they may be composed of a buoyant material (for example, but not limited to, polystyrene), or they may be filled with air, or a combination thereof.

The first connecting member is preferably configured to extend over the top of and in contact with the user's head, and the second connecting member is preferably configured to extend across and in contact with the lower back of the user's head. The first and second connecting members may be composed of a buoyant material or any material that is obvious to one skilled in the arts, (for example, but not limited to elastic material or material filled with air or a combination thereof). In an embodiment, the first and second members are cords. The first and second connecting members may even comprise a single length of cord that is attached or connected to the flotation members, for example passing through holes in the flotation members. At least one of the connecting member is preferably of greater length than the second connecting member, such that the open space is generally ovoid, which may provide a better fit to the back of the user's head. As obvious to one skilled in the arts, the cord may be composed of a buoyant material or air-filled material similar to the connecting members.

In exemplary embodiments of the method according to the present invention, wherein the first connecting member is configured to extend over the top of and in contact with the user's head, and the second connecting member is configured to extend across and in contact with the lower back of the user's head, the preferred method comprises the further steps after step a and before step c: positioning the first connecting member to extend over the top of and in contact with the user's head, and positioning the second connecting member to extend across and in contact with the lower back of the user's head. Further, wherein at least one of the first and second connecting members are of adjustable length, the preferred method comprises the further step before step c of adjusting at least one of the first and second connecting members to secure the flotation device to the user's head. This adjustment may include the use of a tie, knot, clasping device or similar apparatus known to one skilled in the arts in order to secure the device to the user's head.

When the first and second flotation members are buoyant, the flotation device can be used to float on one's back. This applies whether floatation members are comprised of buoyant material or they may be filled with air or a combination thereof. However, use of the flotation device to float on one's stomach depends on the type of material and design of flotation members. For example, if the buoyant material is rigid (for example, polystyrene), the design of the flotation device must be modified, in a manner known to one skilled in the art. Furthermore, the width of the base of the floatation members may vary in comparison to their length; however, as the width is reduced, the user experiences less resistance, or if the width is increased, the user will experience more resistance while floating and performing cervical neck rotations on his or her back.

It is also within the scope of the present invention for each of the first and second flotation members to comprise discrete, spaced-apart anterior and posterior portions, each of the respective anterior and posterior portions parings connected by means of lateral connecting members. These anterior and posterior portions enable the user to use this device while floating on his/her back or stomach and help support the spine.

A detailed description of exemplary embodiments of the present invention is given in the following. It is to be understood, however, that the invention is not to be construed as being limited to these embodiments.

### BRIEF DESCRIPTION OF THE DRAWINGS

In the accompanying drawings, which illustrate exemplary embodiments of the present invention:

FIG. 1a is a top plan view of a first flotation device according to the present invention;

FIG. 1b is a bottom plan view of the flotation device of FIG. 1;

FIG. 2a is a rear view of the flotation device of FIG. 1 in use;

FIG. 2a is a rear view of the flotation device of FIG. 1 in use;

FIG. 3 is a cross-sectional view across line 3-3 of FIG. 1;

FIG. 4a is a top plan view of a second embodiment of the present invention;

FIG. 4b is a rear view of the flotation device of FIG. 4a in use; and

FIG. 4c is a front view of the flotation device of FIG. 4a in use.

Preferred embodiments of the present invention will now be described with reference to the accompanying drawings.

### DETAILED DESCRIPTION

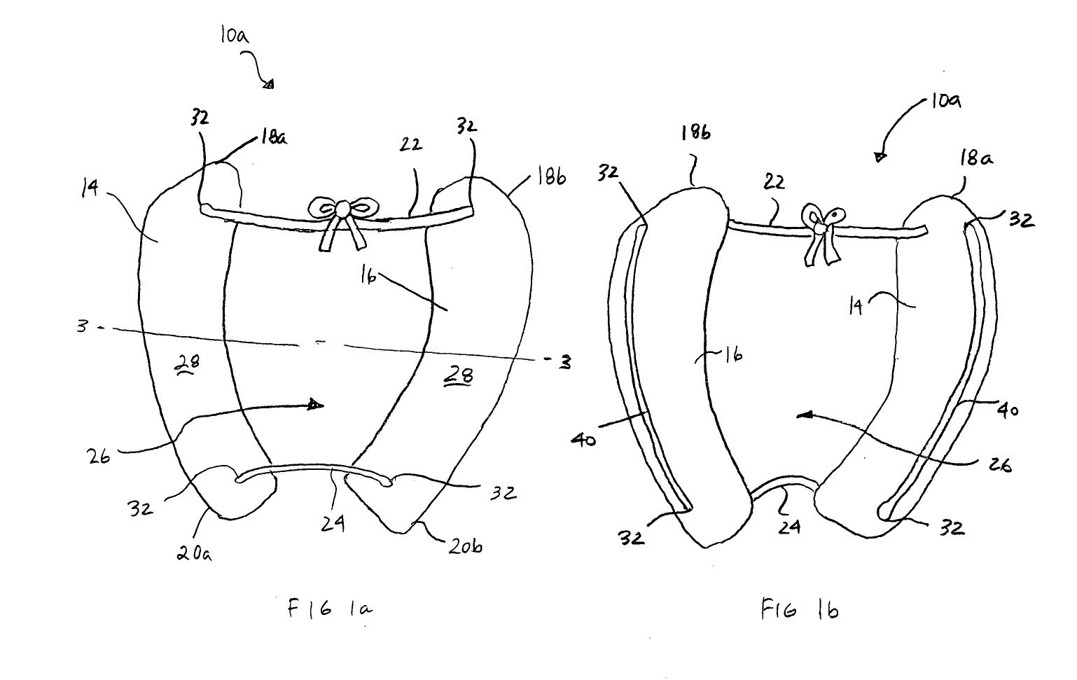

Referring to FIGS. 1a and 1b, a flotation device 10a in accordance with the present invention is illustrated. The flotation device 10a comprises a first flotation member 14 and a second flotation member 16. As can be seen in the drawings, this embodiment employs a single length of cord 40 which passes through holes 32 to bind the flotation members 14, 16 together and form the ring with which the open space 26 is defined. The cord 40 comprises the first connecting member 22 and the second connecting member 24. It will be clear to one skilled in the art that two separate cords may be used for the connecting member 22, 24 rather than a single long cord 40. In fact, the connecting members 22, 24 may, or may not be buoyant. If buoyant, the may be composed of any buoyant material or they may be air-filled or combination thereof. In addition, the connecting members may or may not be elastic as known to one skilled in the arts. The connecting member 22, 24—whether discrete elements or part of a signal cord 40—connect the flotation members 14, 16, the first connecting member 22 connecting the first end 18a of the first flotation member 14 to the first end 18b of the second flotation member 16, and the second connecting member 24 connecting the second end 20a of the first flotation member 14 to the second end 20b of the second flotation member 16. At least one of the connecting members (22, 24) is adjustable through the use of a tie, knot, clasping device or another apparatus known to one skilled in the arts in order to secure the flotation device to the user's head.

The use of connecting members 22, 24 may allow for some limited movements characterized by producing continuous movement that is smoother and more comfortable; and 2) reducing contact of the device with injuries on the body of the user. The flotation device stabilizes and floats the neck and head while making minimal contact with the user's body in order to avoid or minimize contact with body injury sites. Also, connecting members can be employed to provide adjustability for different sized heads. Alternatively, the device 10a may simply be made in different non-adjustable or self-adjusting sizes. In addition, the user can introduce knots in the cord or some other form of texture to hold the flotation members 14, 16 in place on the cord 40. Other means of securing the flotation members 14, 16 in place on the cord 40 would be obvious to one skilled in the art.

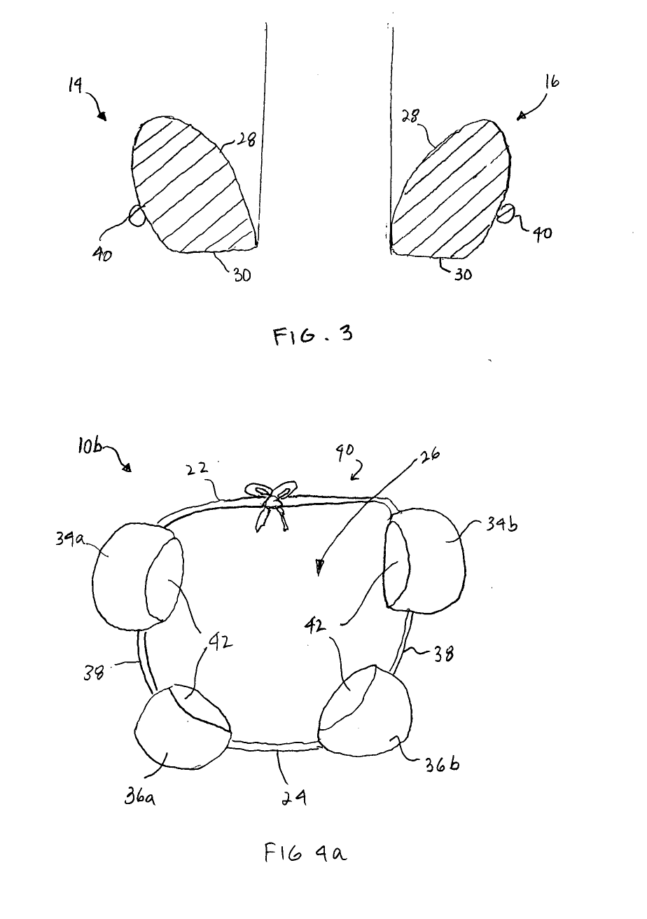

In the illustrated embodiment, the flotation members 14, 16 have a distinctive shape that may help with both comfort and smooth operation within the pool. The upper surface 28 of each flotation member 14, 16 is angled to provide a cradling or nesting of a user's head when wearing the device 10a. The angle may be between 15 degrees and 45 degrees, or between 20 degrees and 40 degrees, or between 25 degrees and 35 degrees, or roughly 30 degrees off of the vertical. This can be seen most clearly in FIG. 3, which is a cross-section of both flotation members 14, 16. This angled shape better mirrors the contour of a user's head, allowing it to be nestled and braced between the flotation members 14, 16. As can be seen in FIG. 3, the bottom surfaces 30 of the flotation members 14, 16 are generally flat and symmetric; although this should not be necessary in every embodiment, it may have the advantage of enabling a smoother movement through the water during pool-based exercises due to continuous contact with water.

The flotation members 14, 16 is preferably composed of polystyrene but can be composed of another similar buoyant material or air-filled material or a combination thereof. As an example, polystyrene works well as a material that helps to produce an effective counterbalance between opposing flotation members 14, 16. In addition, the flotation member 14, 16 are preferably composed of a material that is not overly smooth, to avoid the risk of shifting and misalignment during use in water, but this may also be addressed by applying texture to the flotation members 14,16, or securing them comfortably snug to the user's head.

Furthermore, the width of the base of the floatation members may vary in comparison to their length; however, as the width is reduced, the user experiences less resistance, or conversely, if the width is increased, the user will experience more resistance while floating and performing cervical neck rotations on his or her back.

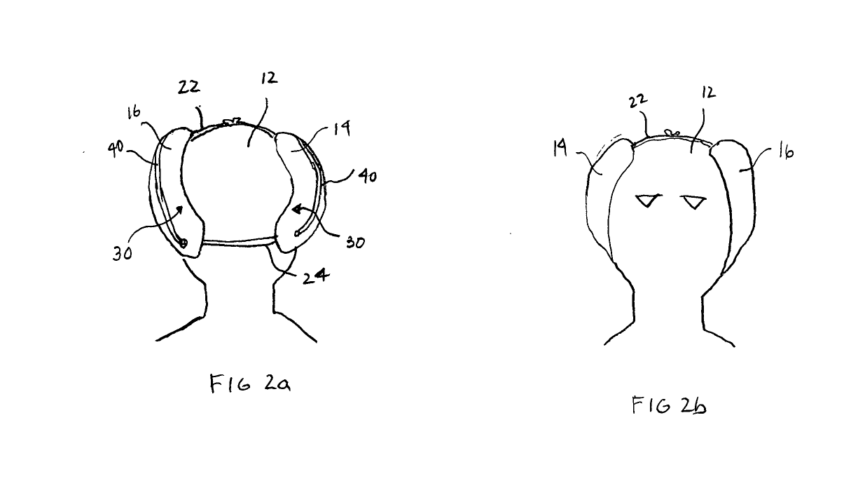

Turning to FIGS. 2a and 2b, the flotation device 10a of FIGS. 1a, 1b and 3 is illustrated in position on a user's head 12. The first connecting member 22 extends across and is in contact with the top of the user's head 12, while the second connecting member 24 extends across the back of the lower part of the neck. This position results in the second 20a, b of the flotation members 14, 16 being in contact with the lower back of the user's head 12, with the first ends 18a, b of the flotation members 14, 16 being in contact with the upper front of the user's head 12. This position helps to support the user's head 12 in proper alignment when floating or swimming on their back. For example, but not limited to, the device helps prevent the user's head from sinking. If the device is made out of polystyrene, it is possible that it can be modified such that the user can use it while floating on his or her stomach. Also, it is possible that one or more different materials are employed in the device (for example, but not limited to polyethylene or an air-filled material) which may also enable the user to use it while floating/exercising on the front or back. For example, but not limited to, the device can be composed of polyethylene and modified which may enable the user to use it while floating on their front or back; albeit, these changes may retain several functions related to the preferred embodiment. During rehabilitation exercises, this position also provides for smoother movement through the water while reducing jerking of the head due to turbulence. The symmetrical design of the device 10a seeks to provide proper balance/counterbalance, with flotation members 14, 16 providing buoyancy to counter that movement, stabilizing the desired head-neck-body alignment even while the user is moving through the water. Stabilizing the neck and head upright in the water has a further advantage of helping to reduce the anxiety in inexperienced swimmers who are undergoing pool-based rehabilitation therapy. A flotation device wherein the flotation members comprise polystyrene may be used while the user is floating on their backs doing rehabilitation exercises. With modifications, which may include the use of a different material, someone skilled in the arts could enable this device to be used by the user on his or her front or back in the water.

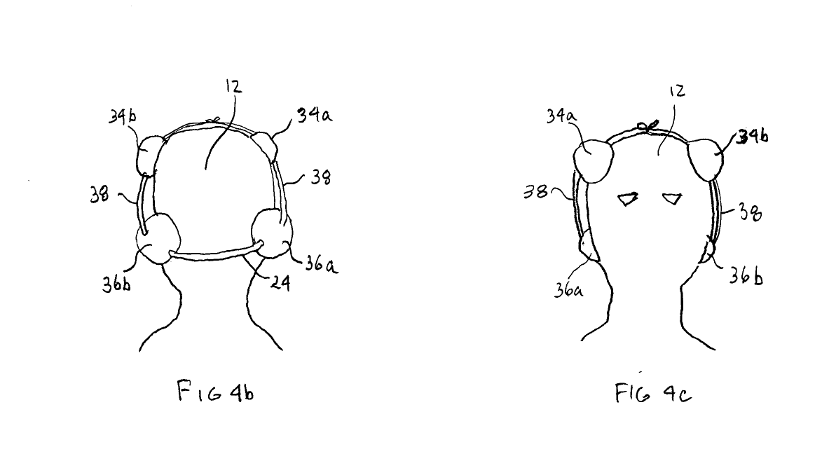

Turning now to FIGS. 4a to 4c, a second embodiment of the present invention is illustrated. In this embodiment, the flotation member 14, 16 of the first embodiment are replaced by discrete, spaced-apart anterior and posterior portions providing the same utility. The flotation device 10b comprises an anterior portion 34a and a posterior portion 36a on one side of the device 10b, and a mirror-image anterior portion 34b and posterior portion 36b on the other side, thereby providing support in a very similar way as the flotation members 14, 16 of the first embodiment. The anterior and posterior portions 34a, 34b, 36a, 36b are provided with flattened surfaces 42, which are the surfaces which will contact the user's head 12, as can be seen in FIGS. 4b and 4c. Although the anterior and posterior portions 34a, 34b, 36a, 36b are illustrated as roughly spherical—other than the flattened surfaces 42—it is not necessary for them to have a spherical shape, as any number of shapes may be easily designed to work as well. The flattened surfaces 42 are necessary to the functioning of this particular embodiment, as otherwise the rounded surfaces would introduce discomfort, pain, shifting and/or instability when making contact with the user's head in and out of the water. The anterior and posterior portions 34a, 34b, 36a, 36b may be buoyant, be either being comprised of buoyant material (for example, but not limited to, polystyrene) or being air-filled material.

The anterior portions 34a, 34b are connected by a first connecting member 22, and the posterior portions 36a, 36b are connected by a second connecting member 24, akin to the basic form in the first embodiment. Given that the anterior and posterior portions 34a, 34b, 36a, 36b are spaced apart; however, additional lateral connecting members 38 are required to complete the connection of all flotation elements and define the open space 26. As with the first embodiments, the connecting members 22, 24, 38 may be composed of some material other than cord, (for example, but not limited to, an air-filled, elastic or buoyant material as obvious to one skilled in the arts) to help with the flotation utility of the device which can be determined by one skilled in the arts. They may be parts of a single cord 40 or discrete sections of cord. A person skilled in the arts can employ more than four portions to represent 14, 16 of FIG. 1, which may require more connecting members.

The connecting member(s) 22, 24 and 38 whether discrete elements or part of a signal cord 40—connect the flotation members 34a, 34b, 36a, and 36b. The first connecting member 22 connects to 34a, 34b. One of connecting members 38 connects 34a and 36a and the other connects 34b and 36b. At least one of the connecting members is adjustable through the use of a tie, clasping device of another adjusting member known by one skilled in the arts in order to secure the flotation device to the user's head.

As can be seen in FIGS. 4b and 4c, the first connecting member 22 extends across and is in contact with the top of the user's head 12, while the second connecting member 24 extends across the back of the lower part of the neck. This position results in the posterior portions 36a, 36b being in contact with the lower back of the user's head 12, with the anterior portions 34a, 34b being in contact with the upper front of the user's head 12, akin to the positioning of the first embodiment.

The use of cords as connecting members 22, 24 and 38 may create limited movements characterized as continuous, thereby producing a more advantageous movement that is smoother and more comfortable. The connecting members may help reduce the contact of the flotation device with the neck and head: the flotation device stabilizes and floats the neck and head while making minimal contact with the body in order to avoid contact with possible sites of injury. Also, the cord connecting members can be employed to provide adjustability for different sized heads by the use of a tie, know, clasping device or another means determined by one skilled in the arts in order to secure the device to the user's head. Alternatively, the device 10b may simply be made in different non-adjustable or self-adjusting sizes. Furthermore, the user can introduce knots in the cord or some other form of texture to hold the flotation members 34a, 34b, 36a and 36b in place on the cord 40. Other means of securing these flotation members in place on the cord 40 would be obvious to one skilled in the art.

As can be readily seen, then, there are numerous advantages provided by the present invention. A flotation device can be used during front and back floating or swimming, countering both rotational and pivoting motions to maintain proper alignment and thus helping to reduce pain or discomfort while performing rehabilitation exercises. The effects of water turbulence around the user can also be countered or reduced. The device is of simple construction is very simple to use, and can even be made to be adjustable for different head sizes and shapes. A further advantage is provided in that the use of a flotation device in accordance with the present invention can help to reduce anxiety in non-swimmers or inexperienced swimmers who are undergoing pool-based rehabilitation therapy. For example, firstly, they can use the device to help support their neck and head and maintain proper alignment while they float face-up performing rehabilitation exercises. Secondly, the device helps prevent the head from sinking backwards which promotes proper alignment.

The foregoing is considered as illustrative only of the principles of the invention. Thus, while certain aspects and embodiments of the disclosure have been described, these have been presented by way of example only and are not intended to limit the scope of the disclosure. Indeed, the invention describe herein may be embodied in a variety of other forms without departing from the scope thereof which invention is defined solely by the claims below.

1. A flotation device for supporting and aligning a user's head during pool-based rehabilitation therapy, comprising:
first and second opposed, spaced apart flotation members, each flotation member having a first end and a second end;
the respective first ends of the first and second flotation members connected by a first connecting member, and the respective second ends of the first and second flotation members connected by a second connecting member;
wherein the first flotation member, first connecting member, second flotation member and second connecting member form a ring defining an open space therein, for receiving the back of the user's head; and the first and second flotation members arranged to abut the lateral sides of the user's head.

2. The flotation device of claim 1 wherein the first and second flotation members have angled upper surfaces for receiving and supporting the user's head.

3. The flotation device of claim 1 wherein buoyancy, of the first and second flotation members, increase resistance to rotation of the user's head.

4. The flotation device of claim 1 wherein the first and second flotation members support proper alignment of the spine or cervical spine.

5. The flotation device of claim 1 wherein the first and second flotation members reduce water turbulence around the user's head.

6. The flotation device of claim 1 wherein the first and second flotation members have a texture that reduces slippage when applied to the user's head.

7. The flotation device of claim 1 wherein the first and second flotation members each have a lower surface that reduces instability around the user's head.

8. The flotation device of claim 1 wherein the first and second flotation members are buoyant.

9. The flotation device of claim 1 wherein the first and second flotation members are adjustable for receiving the user's head.

10. The flotation device of claim 1 wherein the first connecting member is configured to extend over a top portion of the user's head, and the second connecting member is configured to extend across a lower back portion of the user's head.

11. The flotation device of claim 1 wherein the first and second connecting members comprise one or more cords.

12. The flotation device of claim 1 wherein the first and second connecting members are composed of a single length of cord.

13. The flotation device of claim 1 wherein the first and second connecting members are buoyant.

14. The flotation device of claim 1, where each of the first and second flotation members comprise: i) at least two sub-members; and ii) one or more lateral connecting members, such that the one or more lateral connecting members sequentially connect the sub-members.

15. The flotation device of claim 14, wherein each flotation member comprises two sub-members connected via one lateral connecting member.

16. The flotation device of claim 14, wherein the one or more lateral connecting members, the first connecting member and the second connecting member form part of a single cord.

17. The flotation device of claim 1 wherein the first and second flotation members contact the user's head along an entire length of each of the first and second flotation member.

18. The flotation device of claim 1 wherein the first and second flotation members are composed of two separate lengths of cord.

19. A method of using a flotation device in pool-based rehabilitation therapy, the flotation device comprising: first a and second opposed, spaced apart flotation members, each having a first end and a second end; the respective first ends of the first and second flotation members connected by a first connecting member, and the respective second ends of the first and second flotation members connected by a second connecting member; such that the first floatation member, first connecting member, second flotation member and second connecting member form a generally ovoid ring defining an open space therein; the method comprising:
a. positioning the flotation device against the back of the user's head, such that the user's head rests generally within the open space;
b. positioning the first and second flotation members against the lateral sides of the user's head; and
c. proceeding with the pool-based rehabilitation therapy.

20. The method of claim 19 wherein the first connecting member is configured to extend over the top of and in contact with the user's head, and the second connecting member is configured to extend across and in contact with the lower back of the user's head, the method comprising the further steps after step a and before step c: positioning the first connecting member to extend over the top of and in contact with the user's head, and positioning the second connecting member to extend across and in contact with the lower back of the user's head.

21. The method of claim 19 wherein at least one of the first and second connecting members are of adjustable length, comprising the further step before step c of adjusting the at last one of the first and second connecting members to secure the flotation device to the user's head.
